(19) United States
(12) Patent Application Publication
(10) Pub. No.: US 2024/0264992 A1
(43) Pub. Date: Aug. 8, 2024

(54) DATA PROCESSING APPARATUS, DATA PROCESSING METHOD, AND DATA PROCESSING PROGRAM

(71) Applicant: NIPPON TELEGRAPH AND TELEPHONE CORPORATION, Tokyo (JP)

(72) Inventors: Nobukazu FUKUDA, Musashino-shi, Tokyo (JP); Chao WU, Musashino-shi, Tokyo (JP); Shingo HORIUCHI, Musashino-shi, Tokyo (JP); Kenichi TAYAMA, Musashino-shi, Tokyo (JP)

(73) Assignee: NIPPON TELEGRAPH AND TELEPHONE CORPORATION, Tokyo (JP)

(21) Appl. No.: 18/565,548

(22) PCT Filed: Jun. 4, 2021
(86) PCT No.: PCT/JP2021/021409

§ 371 Date: Nov. 30, 2023

(51) Int. Cl. G06F 16/22

(52) U.S. Cl. CPC G06F 16/2228

(57) ABSTRACT

A data processing device of the embodiment includes a storage circuit and a processor. The storage circuit is capable of storing a first template. The processor executes analysis processing on input log data. In the analysis processing, the processor divides the log data into tokens (unigrams), each of the tokens including a word and position information of the word, computes a similarity SIM on the basis of the number of tokens common to the log data and the first template and the number of tokens of the first template, and updates the first template on the basis of the similarity SIM.

### TECHNICAL FIELD

The embodiment relates to a data processing device, a data processing method, and a data processing program.

### BACKGROUND ART

Computers may record logs of events that have occurred. The logs are data in which information regarding the events that have occurred is recorded and accumulated in time series, and is used, for example, to identify a cause of an abnormality that has occurred. Examples of the log data include system logs, error logs, and access logs, and various data formats can be used. The log data is massive, and it is desired to speed up analysis of the log data. Speeding up of analysis of the log data may result in speeding up of the entire processing including the subsequent processing.

A method for extracting a template from log data and performing clustering is known as a technology for analyzing log data in a text format. Non Patent Literature 1 discloses a technique using a longest common substring (LCS). Non Patent Literature 2 discloses a technique of formulating log data analysis as an optimization problem and using evolutionary computation. Non Patent Literature 3 discloses a technique of using a prefix tree to extract a common template. Non Patent Literature 4 discloses a technique using a dynamic inverted index.

### CITATION LIST

### Non Patent Literature

Non Patent Literature 1: M. Du and F. Li, “Spell: Streaming Parsing of System Event Logs”, 2016 IEEE 16th International Conference on Data Mining (ICDM), Barcelona, Spain, 2016, pp. 859-864, doi: 10.1109/ICDM.2016.0103.
Non Patent Literature 2: S. Messaoudi, A. Panichella, D. Bianculli, L. Briand and R. Sasnauskas, “A Search-Based Approach for Accurate Identification of Log Message Formats”, 2018 IEEE/ACM 26th International Conference on Program Comprehension (ICPC), Gothenburg, Sweden, 2018, pp. 167-16710
Non Patent Literature 3: P. He, J. Zhu, Z. Zheng and M. R. Lyu, “Drain: An Online Log Parsing Approach with Fixed Depth Tree”, 2017 IEEE International Conference on Web Services (ICWS), Honolulu, HI, USA, 2017, pp. 33-40, doi: 10.1109/ICWS.2017.13.
Non Patent Literature 4: S. Huang et al., “Paddy: An Event Log Parsing Approach using Dynamic Dictionary”, NOMS 2020-2020 IEEE/IFIP Network Operations and Management Symposium, Budapest, Hungary, 2020, pp. 1-8, doi: 10.1109/NOMS47738.2020.9110435.

### SUMMARY OF INVENTION

### Technical Problem

However, the techniques of Non Patent Literatures 1 to 4 have a problem in that the analyze takes time since search of a template similar to log data and computation of similarity between the log data and the template are performed in stages.

### Solution to Problem

A data processing device of the embodiment includes a storage circuit and a processor. The storage circuit is capable of storing a first template. The processor executes analysis processing on input log data. In the analysis processing, the processor divides the log data into tokens, each of the tokens including a word and position information of the word, computes a similarity on the basis of the number of tokens common to the log data and the first template and the number of tokens of the first template, and updates the first template on the basis of the similarity.

### Advantageous Effects of Invention

The data processing device of the embodiment allows for an improvement in efficiency of analyzing log data.

### BRIEF DESCRIPTION OF DRAWINGS

FIG. 1 is a schematic diagram illustrating a usage example of a data processing device according to an embodiment.

FIG. 2 is a block diagram illustrating an example of a hardware configuration of the data processing device according to the embodiment.

FIG. 3 is a block diagram illustrating an example of a functional configuration of the data processing device according to the embodiment.

FIG. 4 is a block diagram illustrating an example of a detailed configuration of a storage unit included in the data processing device according to the embodiment.

FIG. 5 is a table illustrating an example of an inverted index stored in the storage unit included in the data processing device according to the embodiment.

FIG. 6 is a table illustrating an example of templates stored in the storage unit included in the data processing device according to the embodiment.

FIG. 7 is a flowchart illustrating an example of analysis processing of the data processing device according to the embodiment.

FIG. 8 is a schematic diagram illustrating a specific example of a part of log data analysis processing by the data processing device according to the embodiment.

FIG. 9 is a schematic diagram illustrating a specific example of a method for calculating similarity of log data by the data processing device according to the embodiment.

FIG. 10 is a schematic diagram illustrating an example of a method for updating a template by the data processing device according to the embodiment.

FIG. 11 is a table illustrating computation times for similarity computation in the embodiment and a comparative example.

FIG. 12 is a graph showing efficiency evaluation results in the embodiment and a comparative example.

### DESCRIPTION OF EMBODIMENTS

Hereinafter, an embodiment will be described with reference to the drawings. The embodiment illustrates a device and a method for embodying the technical idea of the invention. The drawings are schematic or conceptual. In the following description, components that have substantially the same functions and configurations are denoted by the same reference numerals.

### EMBODIMENT

Hereinafter, a data processing device 10 according to the embodiment will be described.

### <1> Configuration

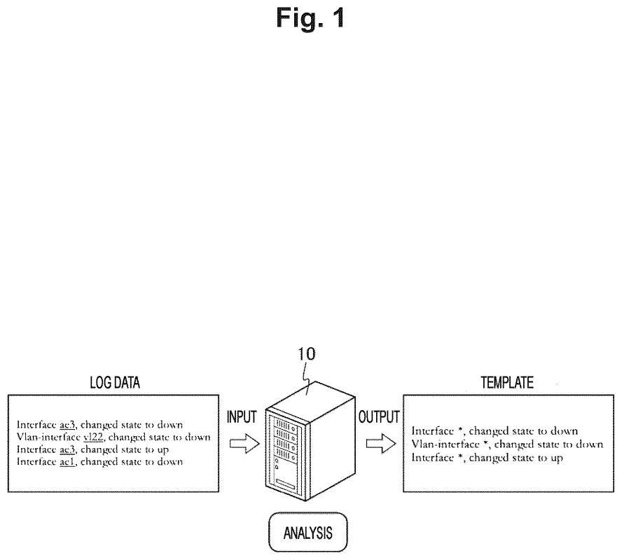

FIG. 1 is a schematic diagram illustrating a usage example of the data processing device 10 according to the embodiment. As illustrated in FIG. 1, the data processing device 10 is a computer capable of analyzing input log data and outputting a template. The data processing device 10 can extract similar portions from the input log data and generate a plurality of templates. “*” included in each template indicates a wildcard. That is, “*” is treated as a parameter in the template. For example, in the log data illustrated in FIG. 1, “ae3”, “v122”, “ac3”, and “ac1” correspond to the parameters. The log data is input to the data processing device 10 via, for example, a network connected in a wired or wireless manner. The data processing device 10 may analyze log data stored in a built-in or externally connected storage device.

### <1-1> Hardware Configuration of Data Processing Device 10

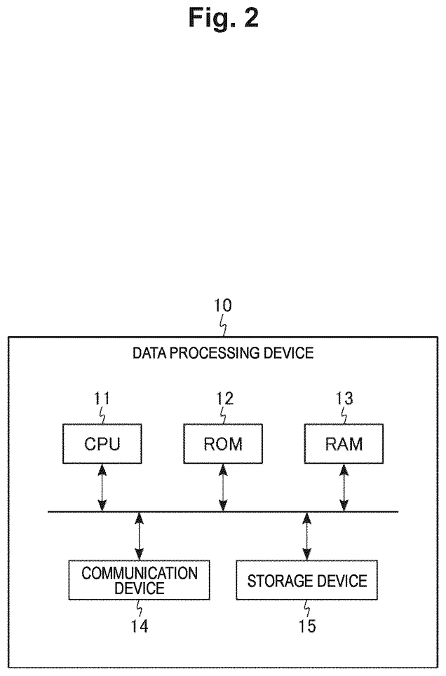

FIG. 2 is a block diagram illustrating an example of a hardware configuration of the data processing device 10 according to the embodiment. As illustrated in FIG. 2, the data processing device 10 includes, for example, a central processing unit (CPU) 11, a read only memory (ROM) 12, a random access memory (RAM) 13, a communication device 14, and a storage device 15.

The CPU 11 is an integrated circuit capable of executing various programs. The CPU 11 controls the entire operation of the data processing device 10. The ROM 12 is a nonvolatile semiconductor memory. The ROM 12 stores a program for controlling the data processing device 10, control data, and the like. The RAM 13 is, for example, a volatile semiconductor memory. The RAM 13 is used as a working area of the CPU 11. The communication device 14 is a communication circuit configured to be connectable to a network. The data processing device 10 can transfer log data received via the communication device 14 to the RAM 13 or the storage device 15, and output an analysis result of the log data to an external device via the communication device 14. The storage device 15 is a nonvolatile storage device. The storage device 15 stores, for example, system software of the data processing device 10, log data acquired via a network, and the like. The data processing device 10 may have another hardware configuration. The data processing device 10 may be connected with a display, an input interface, a detachable storage device, or the like.

### <1-2> Functional Configuration of Data Processing Device 10

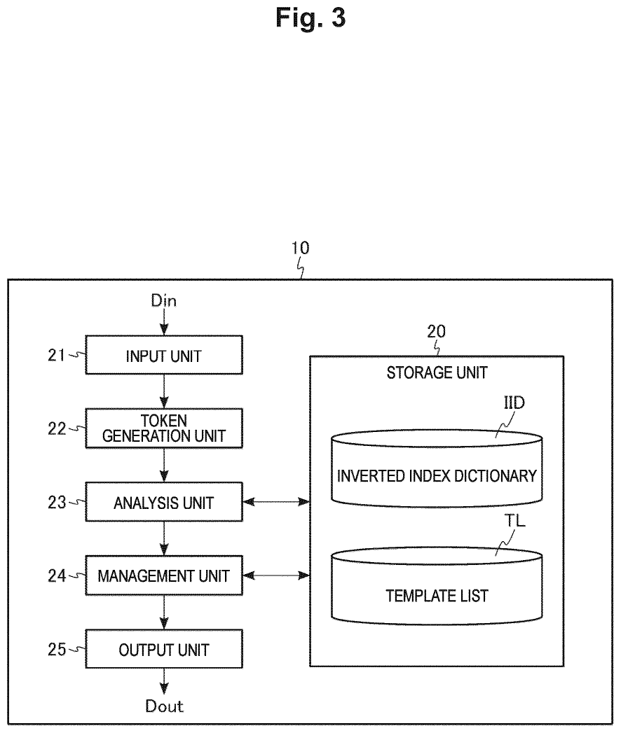

FIG. 3 is a block diagram illustrating an example of a functional configuration of the data processing device 10 according to the embodiment. As illustrated in FIG. 3, the data processing device 10 includes, for example, a storage unit 20, an input unit 21, a token generation unit 22, an analysis unit 23, a management unit 24, and an output unit 25.

The storage unit 20 stores an inverted index dictionary IID and a template list TL used in log data analysis processing by the data processing device 10. An inverted index dictionary IID includes a plurality of inverted indexes. An inverted index is, for example, a hash table in which a word is used as a key and a set of templates including the word is used as a value.

The input unit 21 receives an input of data Din. The input unit 21 extracts log data in a text format from the data Din, and inputs the extracted log data to the token generation unit 22. At the time of extracting log data, the input unit 21 may perform processing of excluding a specific phrase or preprocessing of replacing a specific phrase with a predetermined phrase.

The token generation unit 22 converts the log data input from the input unit 21 from data in a text format into token sequence data. Then, the token generation unit 22 inputs the converted log data to the analysis unit 23. In the data processing device 10, a token is a unigram with position information, and corresponds to a combination of a word and information regarding the position where the word appears. In the present specification, a log length L of log data is defined by the number of tokens included in the log data. For example, in a case where log data includes six tokens, the log length of the log data is L=6.

The analysis unit 23 analyzes the log data input from the token generation unit 22 by using the inverted index dictionary IID and the template list TL stored in the storage unit 20. Then, the analysis unit 23 inputs an analysis result of the log data to the management unit 24.

The management unit 24 appropriately updates the inverted index dictionary IID and the template list TL stored in the storage unit 20 on the basis of the analysis result of the log data input from the analysis unit 23. In addition, the management unit 24 extracts template possibilities on the basis of the analysis result of the log data, and inputs a result of the extraction to the output unit 25.

The output unit 25 outputs data Dout as the result of extracting the template possibilities input from the management unit 24. The destination to which the result of extracting the template possibilities is output by the output unit 25 can be appropriately changed in accordance with settings of a program executed by the CPU 11.

In the data processing device 10, processing of the storage unit 20 is implemented by, for example, the RAM 13. Processing of the input unit 21 is implemented by, for example, the CPU 11, the RAM 13, and the communication device 14. Processing of the token generation unit 22 is implemented by, for example, the CPU 11 and the RAM 13. Processing of the analysis unit 23 is implemented by, for example, the CPU 11 and the RAM 13. Processing of the management unit 24 is implemented by, for example, the CPU 11 and the RAM 13. Processing of the output unit 25 is implemented by, for example, the CPU 11, the RAM 13, and the communication device 14. The functional configuration of the data processing device 10 is not limited to this, and other classifications may be applied.

### <1-3> Configuration of Storage Unit 20

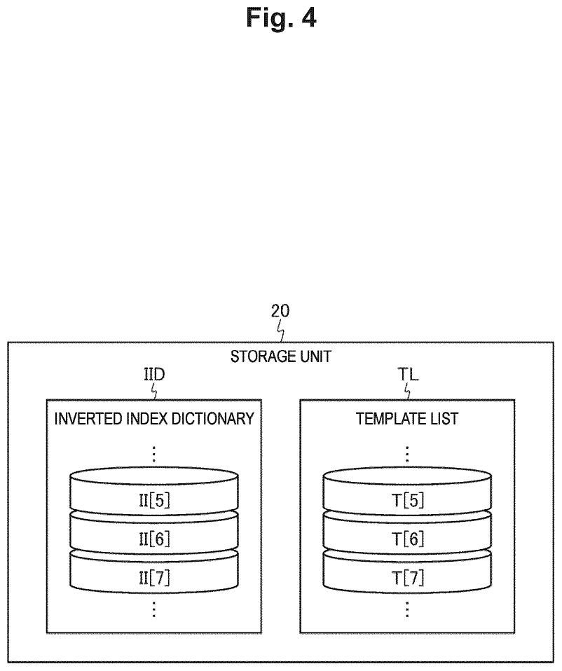

FIG. 4 is a block diagram illustrating an example of a detailed configuration of the storage unit 20 included in the data processing device 10 according to the embodiment. As illustrated in FIG. 4, the inverted index dictionary IID includes a plurality of inverted indexes II, and the template list TL includes a plurality of templates T.

The illustrated inverted indexes II [5], II [6], and II [7] are associated with log lengths L=5, L=6, and L=7, respectively. That is, the inverted index dictionary IID has an inverted index II for each log length L. Hereinafter, an inverted index II associated with a log length L is referred to as an inverted index II [L].

The illustrated templates T[5], T[6], and T[7] are associated with template IDs=“5”, “6”, and “7”, respectively. As described above, a template list TL includes a plurality of templates associated with template IDs. Hereinafter, a template T associated with a certain template ID is referred to as a “T [ID]”.

Note that the details of the inverted index dictionary IID and the template list TL illustrated in the drawing are merely examples. The types and the number of inverted indexes II included in an inverted index dictionary IID can vary depending on the type and the number of log lengths L detected on the basis of analysis results of a plurality of pieces of log data input to the data processing device 10. In addition, each of the number of templates included in a template list TL and association of each template with a template ID can vary depending on how the templates are managed.

### <1-4> Configuration of Inverted Index II

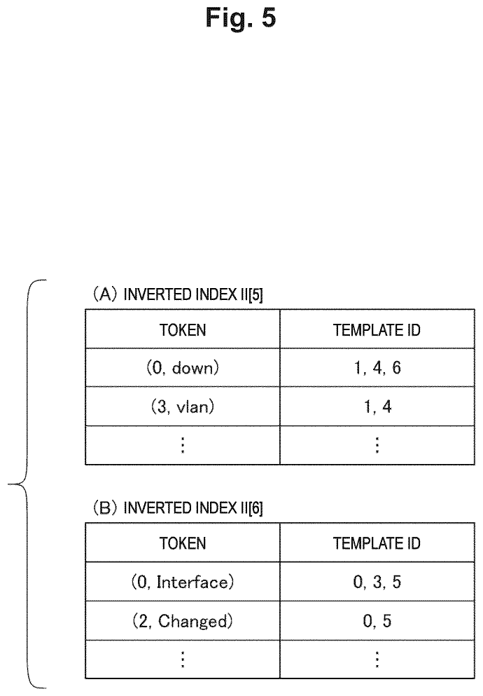

FIG. 5 is a table illustrating an example of the inverted indexes II [L] stored in the storage unit 20 included in the data processing device 10 according to the embodiment. (A) and (B) of FIG. 5 illustrate inverted indexes II associated with log lengths L=5 and L=6, respectively. The inverted indexes II [L] use tokens as keys and sets of templates including the tokens as values. In the following description, it is assumed that the addresses [0], [1], . . . , and the like are assigned as parameters representing the positions of words in the log data in the order of appearance of the token sequence data.

As illustrated in (A) of FIG. 5, in the present example, a token (0, down) and a token (3, vlan) are recorded in the inverted index II[5]. The token (0, down) corresponds to the fact that the word located at the address [0] is “down” in the log data. The template IDs=1, 4, and 6 associated with the token (0, down) indicate that each of the templates T[1], T[4], and T[6] includes the token (0, down). Similarly, the token (3, vlan) corresponds to the fact that the word located at the address [3] is “vlan” in the log data. The template IDs=1 and 4 associated with the token (3, vlan) indicate that each of the templates T[1] and T[4] includes the token (3, vlan).

As illustrated in (B) of FIG. 5, in the present example, a token (0, Interface) and a token (2, Changed) are recorded in the inverted index II[6]. The token (0, Interface) corresponds to the fact that the word located at the address [0] is “Interface” in the log data. The template IDs=0, 3, and 5 associated with the token (0, Interface) indicate that each of the templates T[0], T[3], and T[5] includes the token (0, Interface). Similarly, the token (2, Changed) corresponds to the fact that the word located at the address [2] is “Changed” in the log data. The template IDs=0 and 5 associated with the token (2, Changed) indicate that each of the templates T[0] and T[5] includes the token (2, Changed).

As described above, each template T associated with an inverted index II [L] has the same log length L as the inverted index II[L]. That is, the template ID to be referred to is different between the inverted index II [5] and the inverted index II [6]. In the present example, one template list TL stores templates T having various log lengths L. The data processing device 10 may create a template list TL for each log length L. In this case, a template ID may overlap between a plurality of template lists TL, and the data processing device 10 manages the templates for each log length L on the basis of, for example, a combination of the ID of the template list TL and the template ID. Furthermore, a template ID may be a hash value of a template character string (e.g., “Interface * changed to *”). Template IDs may be managed by another method as long as the analysis processing described below can be executed, and the method is not limited to a specific method.

### <1-5> Configuration of Template T

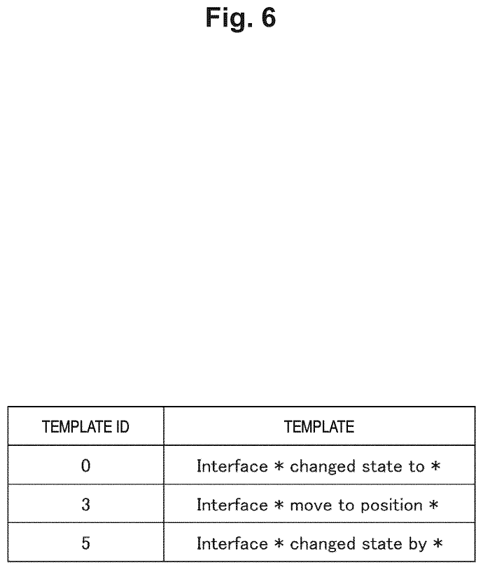

FIG. 6 is a table illustrating an example of templates T stored in the storage unit 20 included in the data processing device 10 according to the embodiment. FIG. 6 illustrates an example of templates associated with the token (0, Interface) in (B) of FIG. 5.

As illustrated in FIG. 6, the template T[0] with the template ID=0 is associated with a template “Interface * changed to *”. The template T[3] with the template ID=3 is associated with a template “Interface * move to position *”. The template T[5] with the template ID=5 is associated with a template “Interface * changed state by *”. The log lengths of these templates, which are associated with the inverted index II[6], are all L=6. The words located at the address [0] of these templates, which are templates T associated with the token (0, Interface), are all “Interface”. The words located at the address [2] of the templates with the template IDs=0 and 5, which are templates T associated with the token (2, Changed), are both “Changed”.

### <2> Operation

The data processing device 10 according to the embodiment creates an inverted index for each log length, searches the inverted index for a template with the largest number of common tokens, and computes similarity from the number of common tokens and the number of tokens of the template. Then, in a case where there is no template that matches log data, the data processing device 10 extracts a template with the highest similarity, and, on the basis of the similarity, combines the existing template with the log data and updates the existing template or adds a new template obtained by the combination to a template list.

Hereinafter, details of the log data analysis processing in the data processing device 10 according to the embodiment will be described. In the present specification, it is assumed that in a case where the computer that records logs uses the same template to record the logs, each piece of log data has the same length, that is, each piece of log data includes the same number of words. In the analysis processing, it is assumed that the data processing device 10 processes input log data row by row, that is, sentence by sentence. The data processing device 10 does not execute, for example, processing of combining templates or dividing a template.

### <2-1> Flow of Analysis Processing

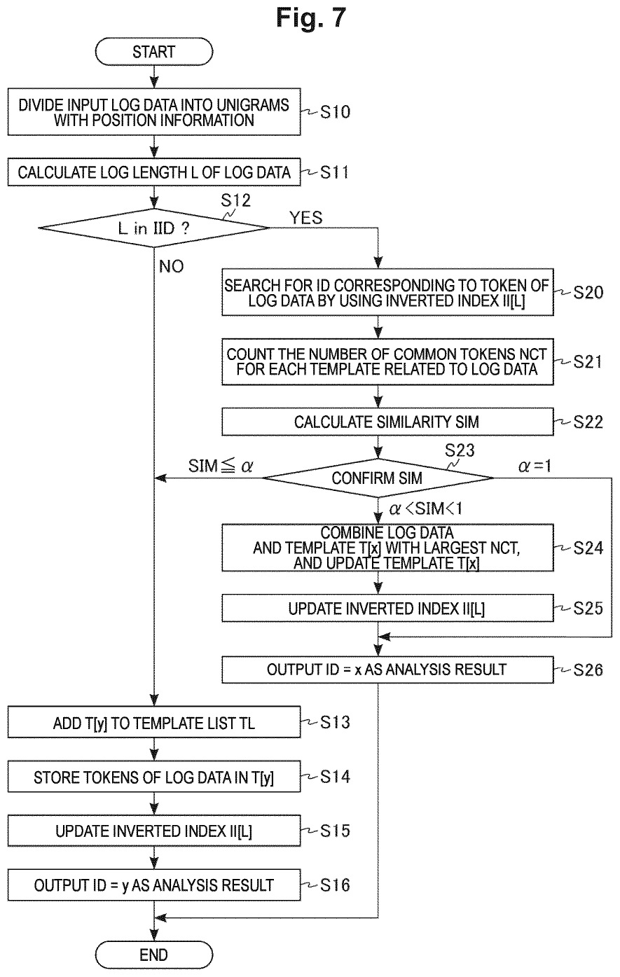

FIG. 7 is a flowchart illustrating an example of analysis processing by the data processing device 10 according to the embodiment. Hereinafter, a flow of the analysis processing by the data processing device 10 according to the embodiment will be described with reference to FIG. 7.

The CPU 11 starts the analysis processing in response to input of log data (START). In other words, the analysis processing starts in response to processed log data being input to the token generation unit 22 by the input unit 21.

First, the CPU 11 divides the input log data into unigrams with position information (step S10). Specifically, the token generation unit 22 divides a text sentence of the input log data on a word-by-word basis, and adds position information (address) to each of the divided words. The unigrams with position information correspond to the tokens of the log data.

Next, the CPU 11 calculates a log length L of the log data (step S11). Specifically, the analysis unit 23 counts the number of tokens included in the log data, and outputs a result of the counting as the log length L.

Next, the CPU 11 checks whether “L in IID” is true (step S12). Specifically, the analysis unit 23 checks whether the inverted index dictionary IID includes an inverted index II [L] corresponding to the log length L calculated in step S11.

In the processing of step S12, if “L in IID” is not true (NO in step S12), that is, if the inverted index II [L] is not included in the inverted index dictionary IID, the CPU 11 adds a template T[y] to the template list TL (step S13). In other words, the management unit 24 registers the new template T[y] in the template list. The “y” corresponds to a template ID that is not used in the current template list TL.

Next, the CPU 11 stores tokens of the log data in the template T[y] (step S14). In other words, the management unit 24 stores token sequence data of the log data in the newly registered template T[y].

Next, the CPU 11 updates the inverted index II [L] (step S15). Specifically, the management unit 24 reflects each token of the newly registered template T[y] in the inverted index II [L], and registers the association between the template T[y] and the existing tokens in the inverted index II [L].

Next, the CPU 11 outputs ID=y as an analysis result (step S16). That is, the output unit 25 outputs the template ID=y of the new template T[y] as a template suitable for the log data input to the data processing device 10. When the processing of step S16 is completed, the CPU 11 ends the series of processing in FIG. 7 (END).

In the processing of step S12, if “L in IID” is true (YES in step S12), that is, if the inverted index II[L] is included in the inverted index dictionary IID, the CPU 11 searches for a template ID corresponding to a token of the log data by using the inverted index II [L] (step S20). Specifically, the analysis unit 23 searches the inverted index II [L] for a token that match the token of the log data. Then, the analysis unit 23 reads the template ID associated with the matched token from the inverted index II [L].

Next, the CPU 11 counts the number of common tokens NCT for each template T related to the log data (step S21). The common tokens are tokens common to the log data and the template, with the order taken into consideration. That is, the common tokens are the same word that appears at the same position in each of the log data and the template. The number of common tokens NCT corresponds to the number of appearances of a template ID in a group of template IDs read for each token of the log data. For example, the analysis unit 23 counts a template ID associated with only one token as “the number of common tokens NCT=1”, and counts a template ID associated with two tokens as “the number of common tokens NCT=2”.

Next, the CPU 11 calculates a similarity SIM (step S22). Specifically, the analysis unit 23 first selects a template T [x] from the template list TL. The “x” corresponds to a template ID with the largest number of common tokens NCT. Then, the analysis unit 23 calculates the similarity SIM by using the following Formula (1) that uses the number of common tokens NCT and the number of tokens NT of the template T [x] and the log length L of the log data.

$$SIM = \{ ( NCT + L ) - NT \} / L \qquad ( 1 )$$

Next, the CPU 11 confirms the similarity SIM (step S23). Specifically, the management unit 24 confirms which one of the conditions “α<SIM<1”, “α=1”, and “SIM≤α” is satisfied by the similarity SIM. The “α” is a threshold used for determination of the similarity SIM, and is, for example, set in advance by a user. Note that “α=1” indicates that the log data matches the template T[x]. The smaller the numerical value of “α”, the lower the similarity between the log data and the template T[x].

In a case where it has been confirmed in the processing of step $23 that “α<SIM<1” is satisfied (α<SIM<1 in step S23), the CPU 11 combines the log data and the template T[x] with the largest number of common tokens NCT, and updates the template T[x] (step S24). In other words, the CPU 11 integrates the log data into the existing template T[x]. Specifically, the management unit 24 uses, as a parameter, a word that does not match between the log data and a template T[x] with a high similarity SIM. That is, the management unit 24 replaces, with a parameter (wildcard), a token in the template T[x] that does not match the log data.

Next, the CPU 11 updates the inverted index II [L] (step S25). Specifically, the management unit 24 reflects the updated template T[x] in the inverted index II [L] to correct mismatch between the inverted index II [L] and the template T [x] generated by the update of the template T[x]. For example, the management unit 24 deletes ID=x from a set of template IDs, in which a token that has been replaced with a wildcard is used as a key, in the inverted index II [L].

Next, the CPU 11 outputs ID=x as an analysis result (step S26). That is, the output unit 25 outputs, as a template suitable for the log data input to the data processing device 10, the template ID=x of the existing template T[x] into which the log data has been integrated. When the processing of step S26 is completed, the CPU 11 ends the series of processing in FIG. 7 (END).

In a case where it has been confirmed in the processing of step S23 that “α=1” is satisfied (α=1 in step S23), the CPU 11 proceeds to the processing of step S26. That is, the CPU 11 outputs ID=x as an analysis result (step S26), and ends the series of processing in FIG. 7 (END).

In a case where it has been confirmed in the processing of step S23 that “SIM≤α” is satisfied (SIM≤α in step S23), the CPU 11 proceeds to the processing of step S13. That is, the CPU 11 adds the new template T[y] to the template list TL on the basis of the log data (step S13), stores the tokens of the log data in the template T[y] (step S14), updates the inverted index II [L] (step S15), outputs ID=y as an analysis result (step S16), and ends the series of processing in FIG. 7 (END).

### <2-2> Specific Example of Analysis Processing

Hereinafter, a specific example of the analysis processing by the data processing device 10 according to the embodiment will be described.

### (Steps S10, S11, S20, and S21)

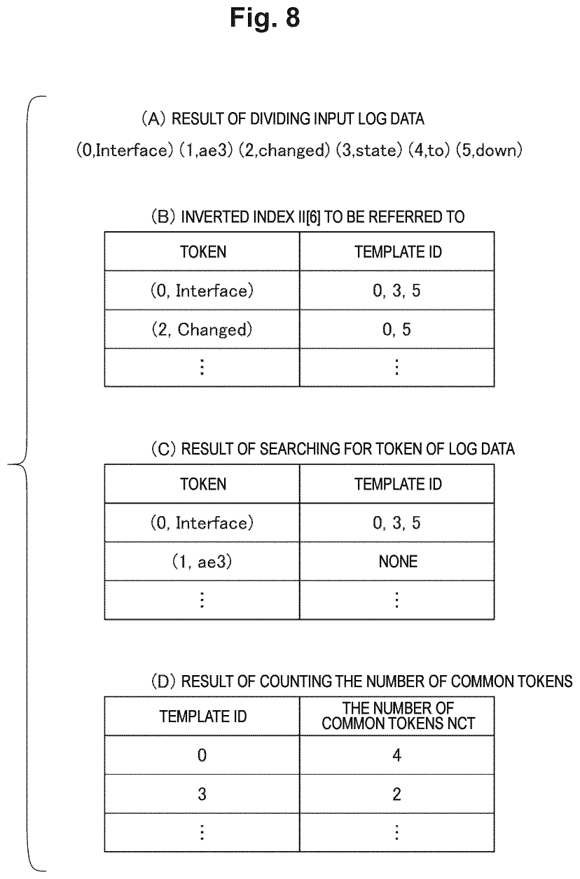

FIG. 8 is a schematic diagram illustrating a specific example of a part of the log data analysis processing by the data processing device 10 according to the embodiment, in which processing corresponding to steps S10, S11, S20, and S21 is extracted and illustrated. In the present example, a case where document data “Interface ae3 changed state to down” is input as log data will be described. (A), (B), (C), and (D) of FIG. 8 illustrate a result of analyzing the input log data, an inverted index II [6] to be referred to, a result of searching for a token of the log data, and a result of counting the number of common tokens, respectively.

When the processing of step S10 is performed on the input log data, the log data is divided into unigrams (tokens) with position information as illustrated in (A) of FIG. 8. Specifically, the log data “Interface ae3 changed state to down” is divided into tokens (0, Interface), (1, ae3), (2, changed), (3, state), (4, to), and (5, down).

As described above, the log data includes six tokens, and the CPU 11 detects that the log length of the log data is L=6 (step S11). Thus, as illustrated in (B) of FIG. 8, the CPU 11 refers to the inverted index II[6] associated with the log length L=6. In the present example, contents of the inverted index II [6] illustrated in the drawing are similar to those of the inverted index II [6] illustrated in (B) of FIG. 5.

Then, the CPU 11 searches for a template ID corresponding to each token of the log data by using the inverted index II[6] (step S20). As a result, in the present example, a search result as illustrated in (C) of FIG. 8 is obtained. For example, the token (0, Interface) is included in the inverted index II [6], and thus the template IDs=0, 3, and 5 are read as a result of searching for the token (0, Interface) of the log data. In addition, the token (1, ae3) is not included in the inverted index II[6], and thus “None” (for example, null data) is assigned as a result of searching for the token (1, ae3) of the log data.

Then, the CPU 11 counts the number of common tokens NCT on the basis of the result of searching for a template ID read to the table illustrated in (C) of FIG. 8 (step S21). As a result, in the present example, the number of common tokens NCT for each template ID is calculated as illustrated in (D) of FIG. 8. In the present example, the number of common tokens of the template ID=0 is NCT=4, and the number of common tokens of the template ID=3 is NCT=2. Then, the CPU 11 refers to the table illustrated in (D) of FIG. 8, extracts (selects) a template with the largest number of common tokens NCT (ID=0 in the present example) as a template with the highest similarity SIM, and executes the subsequent processing.

### (Steps S22 and S23)

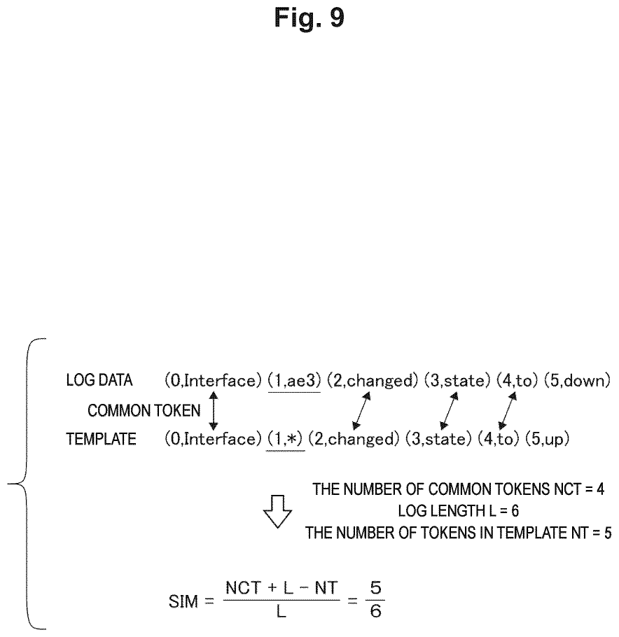

FIG. 9 is a schematic diagram illustrating a specific example of a method for calculating the similarity SIM of log data by the data processing device 10 according to the embodiment, in which processing corresponding to steps S22 and S23 is extracted and illustrated. The present example describes a case of computing the similarity SIM between log data “(0, Interface) (1, ae3) (2, changed) (3, state) (4, to) (5, down)” and a template “(0, Interface) (1, *) (2, changed) (3, state) (4, to) (5, up)”. In a template, an element including “*” such as (1, *) is a parameter of the template, and is not included in counting of the number of tokens NT.

As illustrated in FIG. 9, the log data and the template include four common tokens: (0, Interface), (2, changed), (3, state), and (4, to). That is, in the present example, the number of common tokens NCT=4 is satisfied. The (1, ae3) in the log data is treated as a parameter since the address [1] of the template is a parameter. Then, the CPU 11 uses the number of common tokens NCT=4, the log length L=6, and the number of tokens in the template NT=5 to compute the similarity SIM as illustrated in the following Formula (2) (step S22).

$$SIM = \{ ( NCT + L ) - NT ) / L = ( 4 + 6 - 5 ) / 6 = 5 / 6 \qquad ( 2 )$$

As described above, in the present example, the similarity SIM=5/6 is obtained. Then, the CPU 11 determines whether to update the template on the basis of the calculated numerical value of the similarity SIM (step S23).

### (Step S24)

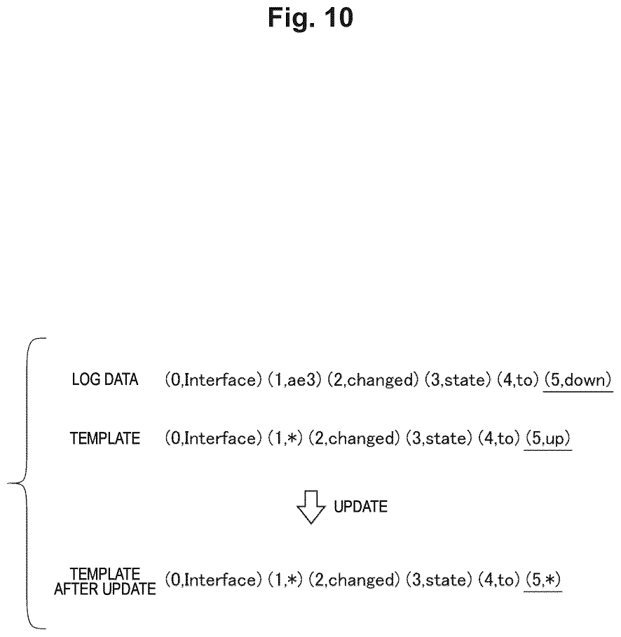

FIG. 10 is a schematic diagram illustrating an example of a method for updating a template T by the data processing device 10 according to the embodiment, in which processing corresponding to step S24 is extracted and illustrated. The present example describes a case where the log data “(0, Interface) (1, ae3) (2, changed) (3, state) (4, to) (5, down)” and the template “(0, Interface) (1, *) (2, changed) (3, state) (4, to) (5, up)” are selected, and “α<SIM<1” is satisfied.

As illustrated in FIG. 10, in a case where the address [1], which is a parameter, is excluded, tokens that are different between the log data and the template are (5, down) in the log data and (5, up) in the template. Then, the CPU 11 updates the template with a template in which only the common tokens remain unchanged (step S24). Specifically, the CPU 11 sets the addresses [1] and [5] as parameters (wildcards), with the common tokens (0, Interface), (2, changed), (3, state), and (4, to) remaining unchanged. As a result, in the template after the update, the token (5, up) in the template before the update has been replaced with a parameter (5, *).

### <3> Effects

The data processing device 10 according to the embodiment uses an inverted index II for each log length L to search for a template having a high similarity SIM with log data, and this makes it possible to search for a template at a high speed. In addition, analysis using unigrams with position information reduces the number of template possibilities for which the similarity SIM is to be computed. Thus, the data processing device 10 according to the embodiment allows for simple and quick computation to obtain a result of searching for a template and the similarity SIM of the log data. That is, the data processing device 10 according to the embodiment can improve efficiency in log data analysis. In addition, the data processing device 10 according to the embodiment can speed up various types of processing such as abnormality detection and compression, thereby speeding up the entire processing of a system that analyzes log data.

### EXAMPLE

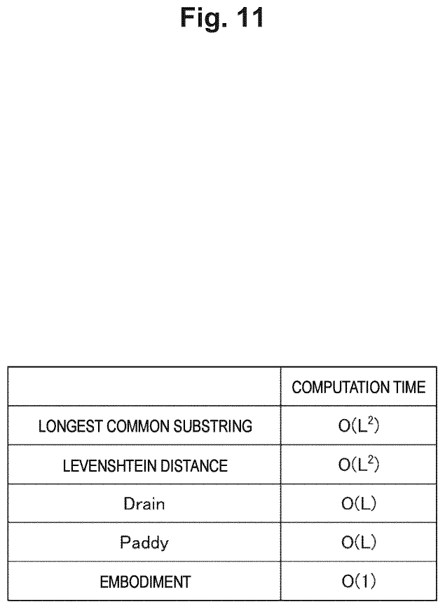

FIG. 11 is a table illustrating the times required for similarity computation in the embodiment and comparative examples (Non Patent Literatures 1 to 4), and illustrates complexity of similarity computation after extraction of template possibilities. The “longest common substring” and “Levenshtein distance” are general techniques for computing similarity between character strings. “Drain” and “Paddy” correspond to Non Patent Literatures 3 and 4, respectively. “L” corresponds to the log length L.

As illustrated in FIG. 11, in a case where the longest common substring is used, the computation time is O(L²). In a case where the Levenshtein distance is used, the computation time is O(L²). In a case where Drain is used, the computation time is O(L). In a case where Paddy is used, the computation time is O(L). In a case where the data processing device 10 according to the embodiment is used, the computation time is 0(1). As described above, the time required for similarity computation in the data processing device 10 according to the embodiment is shorter than that in any of the methods in Non Patent Literatures 1 to 4. That is, the data processing device 10 according to the embodiment can compute similarity faster than the comparative examples.

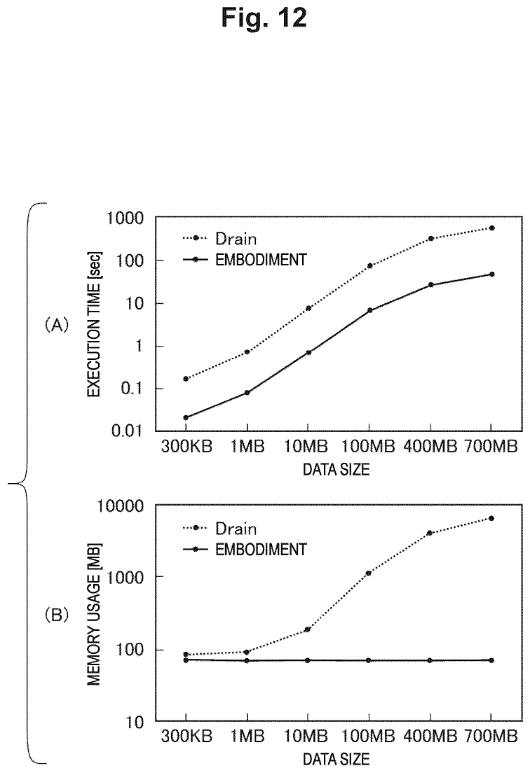

FIG. 12 is a graph showing efficiency evaluation results of the embodiment and a comparative example (Drain). (A) of FIG. 12 illustrates a relationship between the data size of log data on which the analysis processing is executed and the execution time [sec] of the analysis processing. (B) of FIG. 12 illustrates a relationship between the data size of log data on which the analysis processing is executed and a memory usage [MB] at the time of analysis.

As illustrated in (A) of FIG. 12, in both the embodiment and Drain, the execution time of the analysis processing increases as the data size of the log data increases. The execution time of the analysis processing in the embodiment is shorter than the execution time of the analysis processing in Drain by about ⅛ in any of the data sizes with which the evaluation has been performed. That is, the data processing device 10 according to the embodiment can execute the analysis processing at a higher speed than in Drain.

As illustrated in (B) of FIG. 12, in a case where the data size is 300 KB, the memory usage in the embodiment and that in Drain are close to each other. However, while the memory usage increases as the data size of the log data increases in Drain, the memory usage is maintained at a constant value regardless of increase in the data size of the log data in the embodiment. Therefore, it can be seen that the analysis processing in the embodiment is executed more efficiently than that in Drain.

### <4> Others

The embodiment illustrates a case where the data processing device 10 handles log data in a text format without distinguishing between upper case and lower case, but the present invention is not limited thereto. The data processing device 10 may distinguish between upper case and lower case when generating a token. The embodiment illustrates a case where similarity of a template with the largest number of common tokens NCT is computed, but the number of common tokens NCT of the template is not limited to the largest number, and may be a predetermined numerical value or more.

The flowchart and the data tables used in the description of the analysis processing in the embodiment are merely examples. In the flowchart illustrated in FIG. 7, as long as a result similar to that in the embodiment is obtained, the order of the pieces of processing may be rearranged within a possible range, or another piece of processing may be added. In the present specification, the data processing device 10 may be referred to as a “server” or a “processing server”. The CPU 11 may be referred to as a “processor”. Each of the ROM 12, the RAM 13, and the storage device 15 may be referred to as a “storage circuit”.

The hardware configuration of the data processing device 10 described in the embodiment is merely an example. The CPU 11 included in the data processing device 10 may be another circuit. For example, the data processing device 10 may use a micro processing unit (MPU), an application specific integrated circuit (ASIC), or a field-programmable gate array (FPGA) instead of the CPU 11. The analysis processing described in the embodiment may be implemented by dedicated hardware. The analysis processing by the data processing device 10 may include both processing executed by software and processing executed by hardware, or may include only one of them.

Note that the present invention is not limited to the above-described embodiment, and various modifications can be made in the implementation stage without departing from the gist of the invention. The embodiments may be appropriately combined and implemented, and in that case, combined effects can be obtained. Furthermore, the above-described embodiment includes various inventions, and various inventions can be extracted by combinations selected from a plurality of disclosed components. For example, even if some components are deleted from all the components described in the embodiment, in a case where the problem can be solved and the advantageous effects can be obtained, a configuration from which the components have been deleted can be extracted as an invention.

### REFERENCE SIGNS LIST

10 Data processing device
11 CPU
12 ROM
13 RAM
14 Communication device
15 Storage device
20 Storage unit
21 Input unit
22 Token generation unit
23 Analysis unit
24 Management unit
25 Output unit

1. A data processing device comprising:
a memory for storing a first template; and
processing circuitry configured to execute analysis processing on input log data, wherein
in the analysis processing, the processing circuitry performs:
dividing the log data into tokens, each of the tokens including a word and position information of the word;
computing similarity on the basis of the number of tokens common to the log data and the first template and the number of tokens of the first template; and
updating the first template on the basis of the similarity.

2. The data processing device according to claim 1, wherein;
the processing circuitry updates the first template while retaining only the tokens common to the log data and the first template in a case where the log data does not match the first template and the similarity exceeds a first threshold.

3. The data processing device according to claim 1, wherein:
the memory stores a first inverted index and a plurality of templates including the first template, and
the processing circuitry reads information of a corresponding template for each token of the log data by using the first inverted index, and computes the similarity on the basis of the information by using the first template with the largest number of common tokens.

4. The data processing device according to claim 3, wherein;
the memory stores a plurality of inverted indexes that include the first inverted index and are associated with log data lengths different from each other, and
the processing circuitry uses the first inverted index for the reading on the basis of matching between a log data length associated with the first inverted index and a log data length of the log data.

5. A data processing method comprising:
dividing input log data into tokens, each of the tokens including a word and position information of the word;
computing similarity on the basis of the number of tokens common to the log data and a first template and the number of tokens of the first template; and
updating the first template while retaining only the tokens common to the log data and the first template in a case where the log data does not match the first template and the similarity exceeds a first threshold.

6. The data processing method according to claim 5, further comprising:
storing, in a memory, a plurality of inverted indexes that include a first inverted index and are associated with log data lengths different from each other and a plurality of templates including the first template;
reading information of a corresponding template for each token of the log data by using the first inverted index on the basis of matching between a log data length associated with the first inverted index and a log data length of the log data; and
computing the similarity on the basis of the information by using the first template with the largest number of common tokens.

7. A non-transitory computer readable medium storing a data processing program for causing a computer to execute:
dividing input log data into tokens, each of the tokens including a word and position information of the word;
computing similarity on the basis of the number of tokens common to the log data and a first template and the number of tokens of the first template; and
updating the first template while retaining only the tokens common to the log data and the first template in a case where the log data does not match the first template and the similarity exceeds a first threshold.

8. The non-transitory computer readable medium according to claim 7, the program further causing the computer to execute:
storing, in a memory, a plurality of inverted indexes that include a first inverted index and are associated with log data lengths different from each other and a plurality of templates including the first template;
reading information of a corresponding template for each token of the log data by using the first inverted index on the basis of matching between a log data length associated with the first inverted index and a log data length of the log data; and
computing the similarity on the basis of the information by using the first template with the largest number of common tokens.
